(19) United States
(12) Patent Application Publication
(10) Pub. No.: US 2013/0311393 A1
(43) Pub. Date: Nov. 21, 2013

(54) Commodity Shipping Management

(71) Applicants: Tony Herbert, London (GB); Daniel Lyons, London (GB); Adam Lewis, New York, NY (US)

(72) Inventors: Tony Herbert, London (GB); Daniel Lyons, London (GB); Adam Lewis, New York, NY (US)

(73) Assignee: CLS Limited, St. Helier (JE)

(21) Appl. No.: 13/826,012

(22) Filed: Mar. 14, 2013

Related U.S. Application Data
(60) Provisional application No. 61/647,820, filed on May 16, 2012.

(51) Int. Cl. G06Q 10/08

(52) U.S. Cl. CPC G06Q 10/0832
USPC 705/332

(57) ABSTRACT

A method and electronic system is provided for managing a commodity shipment or container shipment. A Statement of Fact (SOF) is maintained on the electronic system; and electronic access is allowed to the SOF by one or more of a plurality of parties involved in the shipment using data communication. A contract for the commodity shipment may be formulated and electronically stored based on the received information from one of the parties. A laytime calculation may be made using information from the SOF and optionally from the contract.

### CROSS-REFERENCE TO RELATED APPLICATIONS

The present application is a non-provisional of and claims priority to U.S. provisional application No. 61/647,820, filed May 16, 2012. The above-mentioned provisional application is incorporated herein by reference in its entirety.

### TECHNICAL FIELD

Aspects described herein relate to a method of managing a commodity shipment using an electronic system, an electronic system for managing a commodity shipment, a method of formulating a contract for a commodity shipment using an electronic system and an electronic system for formulating a contract for a commodity shipment.

### BACKGROUND

Commodity shipment is a complicated process, which can involve one or more buyers, one or more sellers, vessel owners, surveyors, floating crane operators, stevedore companies, shipping agents and other parties.

In order to understand this better, it is useful to mention the main procedural steps in management of the commodity shipment briefly. A Sales and Purchase (S&P) contract is negotiated and agreed between a buyer and a seller. Different types of contract may be possible. For example, in a Free on Board (FOB) contract, the buyer is responsible for shipment of the supplied commodity and in a Carrier and Freight (CNF) contract, the seller is responsible for shipment of the commodity being supplied. Such contracts are detailed and can be based on templates. They can also be linked to one or more charter parties, which are contracts for the chartering of a vessel (a ship). S&P contracts and charter parties are normally exchanged by email or in paper format.

When a vessel arrives at a port of loading or discharge, the master of the ship or an agent provides a Notice of Readiness (NOR). This informs the charterer that the ship has arrived at the port and is ready in all respects to load or discharge. In commercial shipping, the term laytime is generally used to refer to the amount of time allowed (in hours or days) spelled out in a voyage charter for the loading and discharging of cargo. If the laytime is exceeded, a demurrage charge is incurred. This is payable to the vessel owner, for the opportunity costs of having their ship in a port longer than expected. On the other hand, if the whole period of laytime is not needed, despatch may be payable by the ship owner to the charterer, depending on the terms of the charter party.

The laytime calculation relies on correct and agreed details being recorded. A Statement of Fact (SOF) is a record of the activity of loading or discharging the commodity at the relevant port. These are used to create timesheets, which are a calculation of the demurrage penalty payable The SOF and timesheets are conventionally managed on a system using office software such as word processors and spreadsheets and may be communicated via email, in a similar way to the S&P contract. They then may need to be printed, signed and possibly stamped.

Existing approaches for managing the shipment process, including formulating and agreement of contracts, progress monitoring and calculation of any payments due under the contract have problems. For example, these approaches can be slow, paper-heavy, complicated, expensive, error-prone, and frustrating to all parties involved. They are also prone to dispute. This can be due to the manual preparation of contracts, slow communication and revision of contracts, inefficient methods of sharing and signing contracts (for example by courier, fax or telex), minimal visibility of the loading and discharging process and payment calculations can be prone to dispute. Container shipments, having similar problems, may be considered as commodity shipments for the purposes of this disclosure.

Although there exist electronic tools for storing, sharing and signing contracts, such as described in U.S. Pat. No. 6,944,648 and in US patent publication number 2008/0209313, these are quite limited in their ability to handle shipping contracts and have no functionality to manage the remainder of the process. A more efficient method of commodity or container shipment management (or similar) is therefore desirable, particularly to mitigate these problems.

### SUMMARY

Against this background, there is provided methods of managing a commodity shipment comprising: maintaining a Statement of Fact (SOF) on an electronic system; and allowing electronic access to the SOF by one or more of a plurality of parties involved in the shipment using data communication. Optionally, the commodity shipment is a container shipment.

Using an electronic system to manage Statements of Fact allows access via data communication. This means that the Statements of Fact can be accessed (including one or more of: viewing; writing; and editing) over networks such as the Internet, which may also permit access via mobile platforms using wireless networks. Any additions or changes made to the Statements of Fact may thereby be viewed instantly. Moreover, communication and collaboration can take place online. Alerts can also be sent electronically. This can reduce costs, become more efficient by saving time, increase transparency, provide clarity on the process, reduce errors and disputes and mitigate operational risk. By using an electronic system, safety, reliability and robustness can be improved.

The parties involved in the shipment may comprise one or more of: a shipment seller; a shipment buyer; a vessel owner; a surveyor; a floating crane operator, a stevedore company; and a shipping agent. Optionally, the shipping agent can act for more than one of the other parties. Dependent on the type of contract, the shipment buyer or the shipment seller may also be a vessel charterer. The vessel charterer may interact with the vessel owner in specific ways. Alternatively, the shipment buyer or the shipment seller may also be the vessel owner.

The method can further comprise: identifying that the SOF has been changed by one of the parties (preferably, the electronic system is configured such that only the shipping agent can change the SOF); and communicating an indication that the SOF has been changed to at least one of the other parties.

Optionally, the method may further comprise: receiving an assignment of a shipping agent or a command from a shipping agent; and initialising the SOF upon receipt of the shipping agent's assignment or command. The assignment or command may be received by data communication. The assignment may be received from a charterer (which may be a shipment buyer or a shipment seller) or from a vessel owner. The command may be received from the shipping agent, for example if a shipping agent creates a stand-alone SOF (based on a contract that is not stored in the electronic system), which they can then share with any relevant parties. In either case, the receipt of the assignment may automatically cause the electronic system to create a blank SOF (that is, initialise the SOF). The shipping agent may be for the loading port or the discharging port. The method optionally further comprises granting read permission for the SOF to one or more of: the shipment seller; the shipment buyer; the vessel owner; the vessel charterer; and shipping agent. Preferably, the method may further comprise granting right permission for the SOF to the shipping agent. Automatic reminders and alerts may be sent to one or more of the parties, thereby avoiding the need to chase agents and/or surveyor companies for documents.

Calculation of laytime may use a timesheet. In the preferred embodiment, the method may further comprise initialising a timesheet at the electronic system. One of the plurality of parties involved in the shipment may be a charterer. This may be the case where a charter party exists. In particular, the charterer may be the buyer or the seller. Additionally, the method optionally further comprises granting read and edit permissions for the timesheet to the: charterer and vessel owner (in the case where a charter party exists); or buyer and seller.

The methods described herein can also be used to electronically manage a Notice of Readiness (NOR). This can come from a ship master, or another party acting on behalf of the ship master, such as a shipping agent. The method may further comprise: receiving a NOR at the electronic system from a shipping agent via data communication; and requesting an electronic acceptance of the NOR for at least one of the parties. The at least one of the parties for requesting the electronic acceptance may depend on the type of S&P contract used. For example, the at least one of the parties may comprise the shipment buyer if an FOB contract (or similar) is used and it may comprise the seller if a CNF contract (or similar) is used. Optionally, the method further comprises: receiving an electronic acceptance for the NOR from the at least one of the parties; and calculating a laytime in response to receipt of the electronic acceptance using the SOF. Use of the electronic system to record the SOF allows the laytime calculation to be made in an efficient way.

Preferably, the method further comprises: calculating a laytime using the SOF. The method may further comprise: receiving a plurality of facts at the electronic system from the shipping agent via data communication; and storing the plurality fact as part of the SOF at the electronic system. Optionally, the step of calculating a laytime using the SOF takes place in response to receiving a first fact from the plurality of facts at the electronic system. The method may further comprise: receiving electronic indications from one or more of the parties regarding the facts. Optionally, the step of calculating the laytime may use the received electronic indications. In the preferred embodiment, timesheets can be automatically generated based on the facts. This may reduce errors and disputes over demurrage or despatch. Reconciliations may not be needed. Invoices may be automatically generated using the timesheets.

Integration of the S&P contract within the electronic system may provide further advantages. Preferably, the method further comprises receiving information regarding a contract for the commodity shipment at the electronic system via data communication from one of the parties. Advantageously, the method may further comprise formulating the contract based on the received information and optionally, electronically storing the formulated contract. Optionally, the information comprises one or more of: the type of contract; information about at least some of the parties; an indication of the contract template; a cargo weight (for example in metric tons); a loading rate (for example in metric tons per day); a discharging rate (for example in metric tons per day); a laytime figure (for instance in days or hours, although this may optionally be determined by the quotient of the cargo weight and loading or discharging rate); a demurrage rate (for instance, in dollars); and a despatch rate (for example, in dollars). Thus, a contract can be readily formulated using information provided and a known template. Advantageously, the information about at least some of the parties may comprise at least one of: name information; contact information (such as an address and/or telephone number); party status information; and electronic communication information (such as an email address).

Beneficially, the method may further comprise: allowing electronic access to the formulated contract to at least one of the other parties (that is, not the party from which information regarding the contract was received at the electronic system). Thus, other parties can view the contract online without the need to track documents using a separate system. Changes to the contract can also be tracked, dependent on the party making the change. The contract can be shared essentially instantly, using electronic communication. The contract may be modified in real time.

Preferably, the method may further comprise: sending an electronic communication from the electronic system to at least some of the parties inviting the at least some of the parties to sign the contract; and receiving an electronic signature from the invited parties. These contracts can be therefore signed electronically without delay, particularly using digital signatures.

Advantageously, the method may further comprise calculating a laytime at the electronic system using the SOF and the contract. Access to both the SOF and the contract may allow further automation of the laytime calculation. For example, this permits calculations to be made using the facts stored in the SOF together with information from the contract, such as a demurrage figure.

A related aspect described herein provides a method of formulating a contract for a commodity shipment, the method comprising: receiving information regarding the contract at an electronic system via data communication from one of a plurality of parties involved in the shipment; and formulating and electronically storing the contracts based on the received information.

According to an illustrative embodiment, a computer readable medium storing a computer program may be configured to carry out the method(s) described herein when operated on a processor. Additionally or alternatively, an electronic system for managing a commodity shipment may be provided, comprising a processor configured to carry out any of the methods described herein. Any specific combination of particular features described herein is also disclosed, even if not explicitly identified.

### BRIEF DESCRIPTION OF THE DRAWINGS

Aspects described herein may be put into practice in various ways, one of which will now be described by way of example only and with reference to the accompanying drawings in which:

FIG. 1 shows a flow chart illustrating general steps of a method for managing a commodity shipment in accordance with the disclosure;

FIG. 2 shows a schematic diagram, illustrating electronic communications between parties for the steps shown in FIG. 1;

FIG. 3 is a schematic diagram of the components for an electronic system in accordance with the disclosure;

FIGS. 4A to 4B depict a more detailed flow chart to implement a method for managing a commodity shipment using an electronic system in accordance with the disclosure;

FIG. 5 shows an example Statement of Facts generated and stored using an electronic system in accordance with the disclosure;

FIG. 6 illustrates an example timesheet for a laytime and demurrage calculation using an electronic system in accordance with the disclosure; and

FIG. 7 shows a sample user interface for the electronic system.

### DETAILED DESCRIPTION

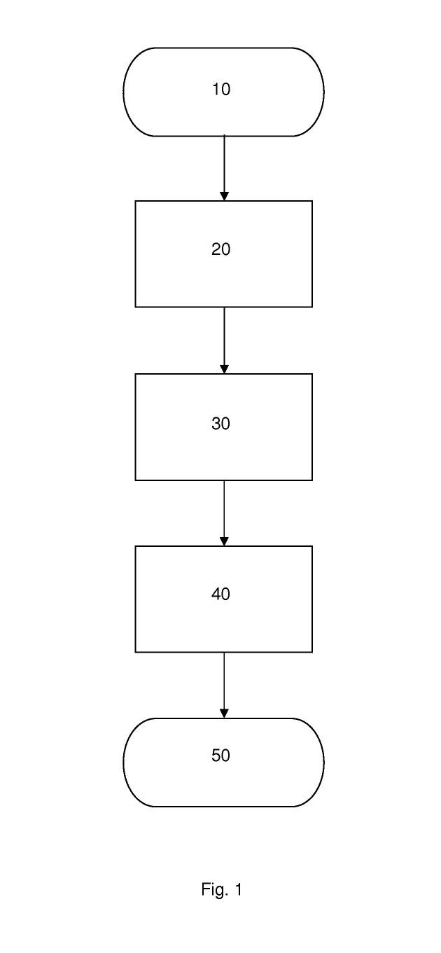

Illustrative embodiments will now be described. Referring first to FIG. 1, there is shown a flow chart illustrating general steps of the method for managing a commodity shipment in accordance with the disclosure. This method is carried out using an electronic system, with an interface for receiving details from a user and an interface for communicating details to a user. These interfaces may use network communication in order to receive data remotely and/or send data remotely. Whilst a commodity shipment is discussed below, it will be appreciated that a similar approach may be taken with respect to a container shipment as well.

The method starts with initialisation step 10. It then proceeds to contract formulation step 20, in which a sales and purchase contract is formulated, based on information provided by a user. In this context, the user is normally either a seller or a buyer of the commodity shipment. Other parties that may be involved in the shipment process may include: a vessel owner; and a shipping agent. For an S&P contract, these may not be involved in the contract formulation step 20, although the vessel owner would be involved in a charter party formulation, as discussed above.

The contract formulation step 20 may include: formulation of a draft contract; provision of access to the draft contract by at least one other party; review of the contract electronically by the other party or parties; revision of the contract by any of the parties; and agreement of the contract. It may also further include electronic signature of the contract. All of these may use the electronic system.

In Statements of Fact (SOF) compilation step 30, the SOF are recorded. These are a record of the activity of loading and/or discharging the commodity at the respective port. The SOF may be entered by a shipping agent and commented upon by the buyer, seller and vessel owner, as appropriate. The statements of fact are electronically stored in the electronic system. This may use memory or other storage components of the electronic system. The electronic system may be a single, stand alone system or it may comprise a distributed system, such as a cloud-based server. Access to the electronic system is provided to all parties, such that the SOF may be added, viewed and edited as appropriate.

Laytime calculation step 40 may involve the calculation of laytime and any demurrage payments or despatch payments due. These may be determined in accordance with the contract formulated in step 20. The SOF established in step 30 may also be used for calculation of the laytime and payments. This may allow automatic calculation of laytime, by pulling data from both the contract and SOF. The relevant parties can access the calculation, which may be implemented by use of a timesheet. The parties can select which facts from the SOF to be used in the calculation. Advantageously, the calculation may thereby be made simple and easy.

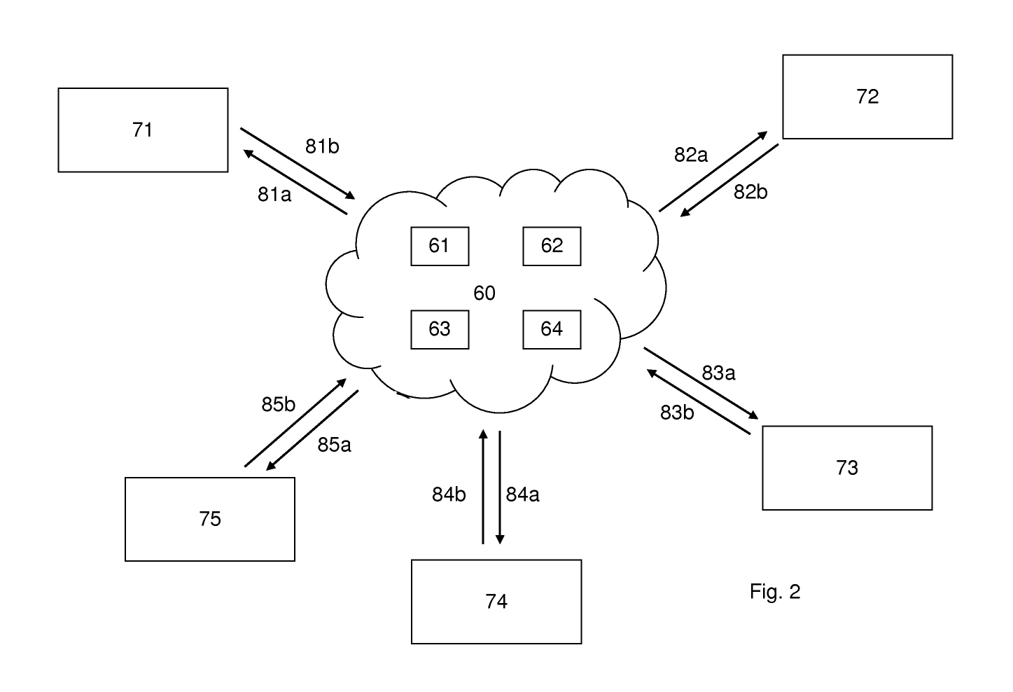

Referring now to FIG. 2, there is shown a schematic diagram illustrating electronic communications between parties for the steps shown in FIG. 1. A server 60 acts as an electronic system, as described above. The parties comprise: a seller 71; a buyer 72; a vessel owner 73; a shipping agent 74; and a surveyor 75. The server 60 may comprise: a contract database 61; an SOF database 62; a client or user database 63; and a timesheet database 64. The server 60 may provide communications via data networks such as the Internet. For example, the server 60 act as a host for a web application in order to allow communications between the parties and the server 60, by each of the parties accessing the web application.

Communications between each of the parties and server comprise inputs (that is, data provided by the respective party to the server 60) and outputs (that is, data provided by the server 60 to the respective party). In particular, communications between the server 60 and the seller 71 comprise: seller outputs 81a; and seller inputs 81b. Seller outputs 81a may include: Contract templates; Contract changes/revisions; Signed contracts; SOF and evidence (docs, photos, weather); Barge, loading, other reports; NOR Tendered/Accepted; Comments; Demurrage calculations; Alert messages; and PDF exports. Seller inputs 81b may include: company info; S&P Contract variables; Charter contract variables; Electronic signatures; Laytime/demurrage variables (if not provided in contracts); Timesheet weightings; Comments; Shared parties email and messages; NOR Acceptance; and Agent assignment.

Communications between the server 60 and the buyer 72 may comprise: buyer outputs 82a; and buyer inputs 82b. Buyer outputs 82a are the same as seller outputs 81a, as described above. Moreover, buyer inputs 82b are the same as seller inputs 81b, as described above.

Communications between the server 60 and the vessel owner 73 may comprise: vessel owner outputs 83a; and vessel owner inputs 83b. Vessel owner outputs 83a are the same as seller outputs 81a, as described above. Vessel owner inputs 83b may include: company info; Charter contract variables; Electronic signatures; Laytime/demurrage variables (if not provided in contracts); Timesheet weightings; Comments; Shared parties email and messages; and Agent assignment.

Communications between the server 60 and the shipping agent 74 may comprise: shipping agent outputs 84a; and shipping agent inputs 84b. Shipping agent outputs 84a may include: Assignment; NOR Acceptance; Weather; Comments; and PDF exports. Shipping agent inputs 84b may include: NOR Tender; Statement of Facts (working records); Barge reports; Loading reports; Supporting evidence; Vessel & Port Info; and Other documents.

Communications between the server 60 and the surveyor 75 may comprise: surveyor outputs 85a; and surveyor inputs 85b. Surveyor inputs 85b may include: Bill of Lading; Certificate of Weights; Certificate of Analysis; Draft or Final survey. The surveyor may be represented by another party, for instance the shipping agent 74.

Other parties not shown in FIG. 2, but which may have access to the server 60 may include: floating crane operators; and stevedore companies. These may submit facts through the shipping agent or directly.

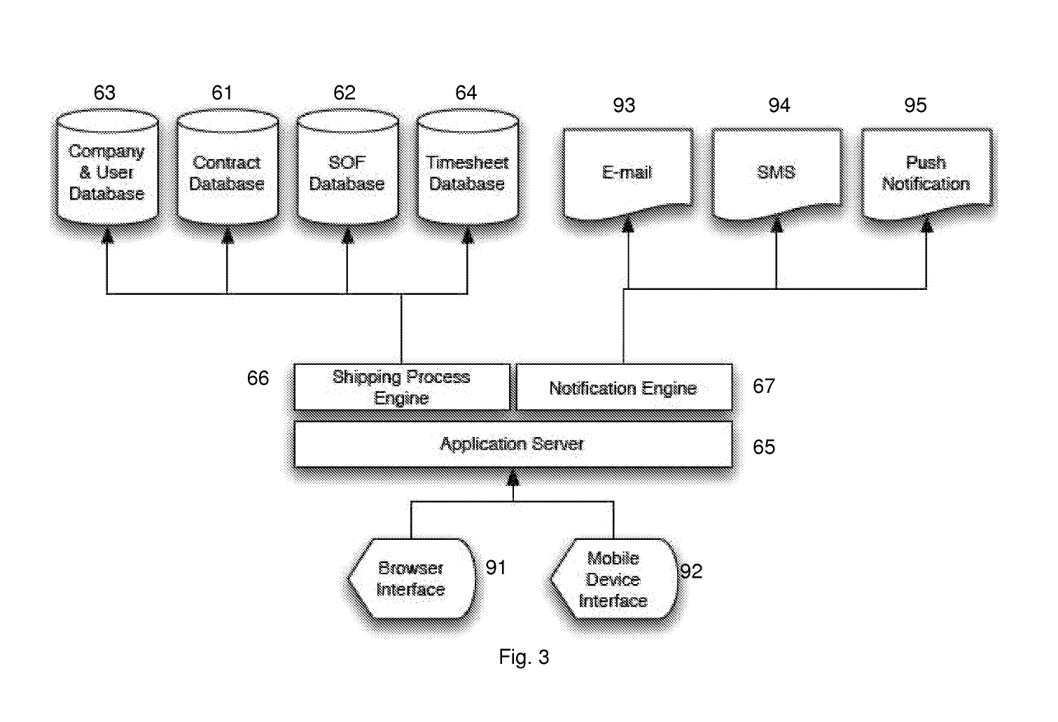

Now referring to FIG. 3, there is shown a schematic diagram of the components for an electronic system or server in accordance with the disclosure. The core parts of the server may comprise: an application server 65; a shipping process engine 66; and a notification engine 67. The application server 65 may receive inputs through a browser interface 91, a mobile device interface 92 or both. A mobile device interface 92 may be configured to cooperate with a client application operative on a mobile device. For example, this application may be specific or native to a particular hardware or operating system. Such applications may be used by one or more parties, especially an on-board Shipping Agent representative (termed “Boarding Officers”), for example to upload facts as they occur. Such an application may be able to work offline and queue facts to be sent as soon as a signal is re-established. Separate applications for buyers and/or sellers with mobile-enhanced and extra features are also possible.

The shipping process engine 66 may interface with one or more of: the company or user database 63; the contract database 61; the SOF database 62; and the timesheet database 64. The notification engine 67 may interact with various communication interfaces including: an email interface 93; a Short Messaging Service (SMS) interface 94; and a Push notification interface 95.

Referring next to FIGS. 3A and 3B, there is depicted a more detailed flow chart to implement a method for managing a commodity shipment using an electronic system in accordance with the disclosure. For the sake of clarity, the flow chart has been split up between these two drawings and where a part of the flow chart shown in FIG. 3A connects with a part shown in FIG. 3B, the same reference numeral 101 has been used to indicate this connection.

In FIG. 3A, a first part of the contract formulation step 20 is shown. The process starts when either the buyer and seller or a charterer and vessel owner make an agreement. The charterer may be a buyer or a seller. A blank S&P contract or charter party may be created as an electronic contract. The contract type may be selected. The identity and status of the parties formulating the contract and of the opposite party in the contract may also be identified by the user. Clauses may be added and edited in an iterative process and inconsistencies identified.

Both forms of contract formulation result in a live electronic contract that may be shared with the other party. A significant difference between the S&P contract formulation and charter party formulation resides in the parties involved: a charter party involves the charterer and vessel owner. The parties may edit the contract by electronic communication with the server 60. Once this process is complete, notification may be provided to all parties that are relevant to sign the contract and allows them to provide electronic signature. Once the contract is fully signed, all parties are notified that the contract is force.

The charter party then assigns a shipping agent at the loading and/or discharging ports. FIG. 3B links the contract formulation step 20 to the statement of fact retrieval step 30. The shipping agent at the relevant port may command the electronic system to create a blank SOF and appropriate permissions may be assigned for reading, writing and editing this by each party registered on the electronic system. A blank timesheet may also be set appropriately and permissions as required are set. The relevant shipping agent may enter a tendered Notice of Readiness (NOR) on behalf of a ship master (assuming that the ship master does not have direct access to the system). This can be accepted by either the seller at the loading port or the buyer at the discharging port, based on the terms of the charter party. In parallel, the may enter facts to the server 60 for storage in the SOF electronically. These may be shared with some or all of the other parties. The other parties can review the facts immediately upon entry, in a live way. Once the shipment is complete, the server 60 is informed that all facts have been recorded.

At this stage, one of the parties (usually, the buyer, seller or vessel owner) initialises an electronic timesheet at the server 60. One or more of the buyer, seller and vessel owner can review and/or comment on the facts and select those facts to be included in the laytime calculation. One or more of the buyer, seller and vessel owner can then mark the timesheets as finalised and all the relevant parties are notified to sign the timesheets. Once the timesheets have been accepted, a signature may be received electronically and the laytime calculation may be automatically made. Multiple timesheets are also possible, for example at a single port (that is, for one SOF). This may occur, for example, when a trader (which may be a buyer or a seller or another party) wishes to create one timesheet for the supplier and another for the vessel owner, with different demurrage levels.

This process may therefore be applicable irrespective of the type of contract (FOB, CNF or other) and the number of parties involved. Use of the server 60 may allow all parties to receive instant live access to one or more of: the contact; the SOF; and the timesheets. Once the process is complete, the parties may agree on the demurrage and despatch payable in accordance with the contract based on the timesheet.

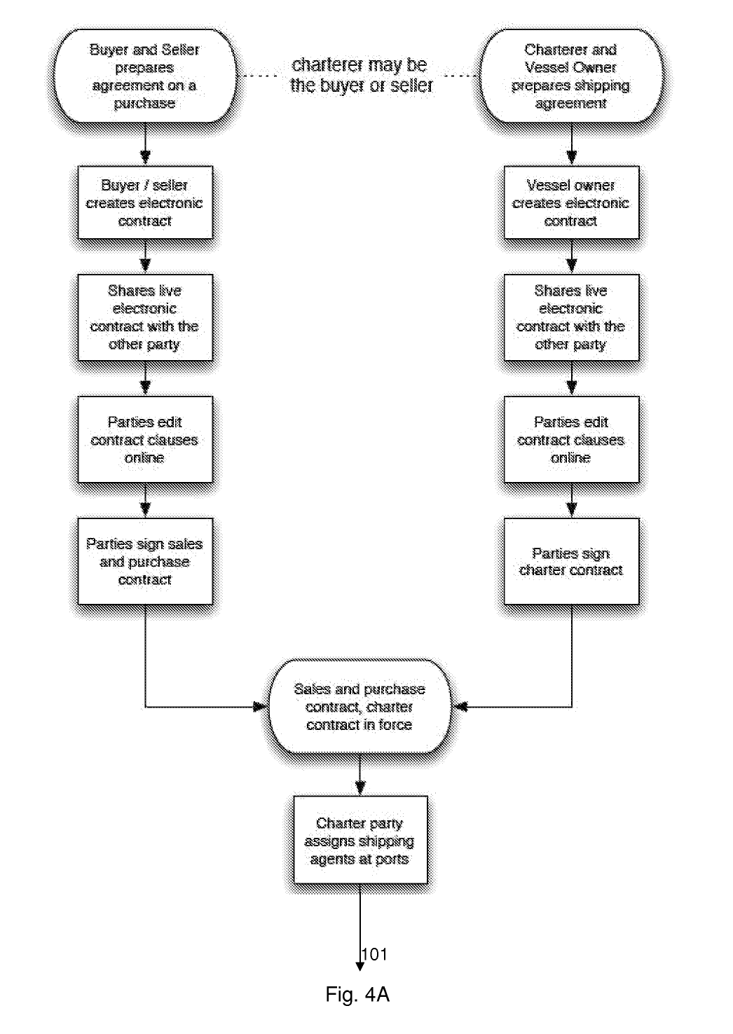

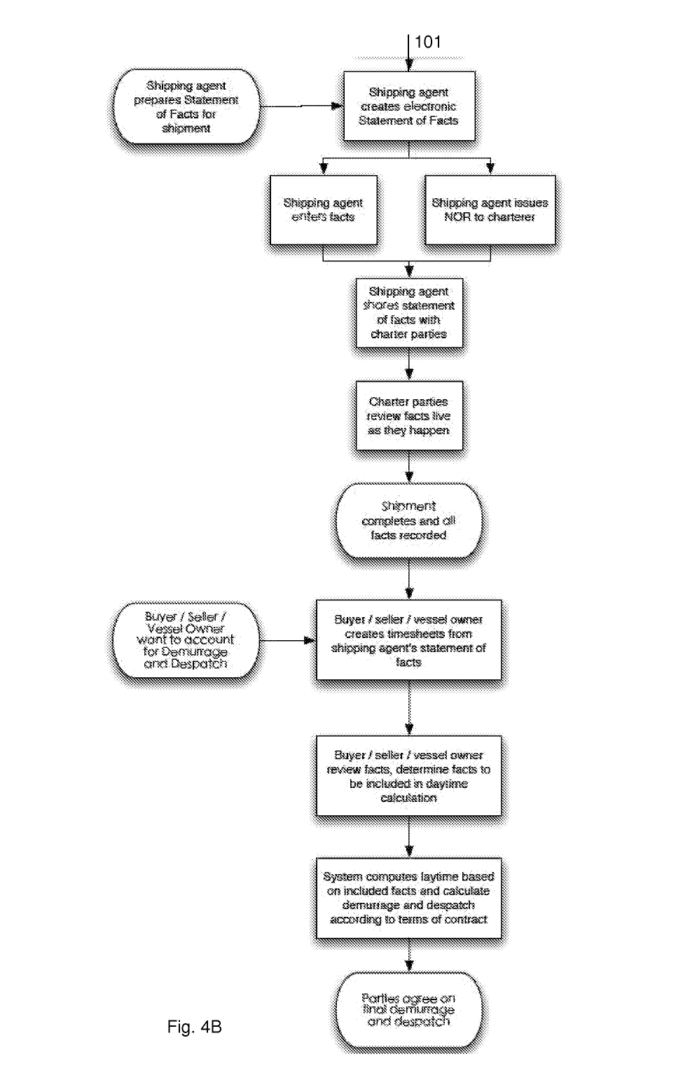

Referring next to FIG. 4, there is shown an example Statement of Facts generated and stored using an electronic system in accordance with the disclosure. Each SOF entry may include: a start date and time; a finish date and time; a weather report; and remarks.

Whenever a fact is submitted, the weather conditions may accompany the fact. The weather may be submitted by the shipping agent or this may be automatic. For example, the electronic device used by the shipping agent (or another party) may comprise an automatic location determination module, such as a Global Positioning System (GPS) device or similar. This may allow a location to be determined, using which the electronic system can responsively identify a weather for that location at the time of submission of the fact.

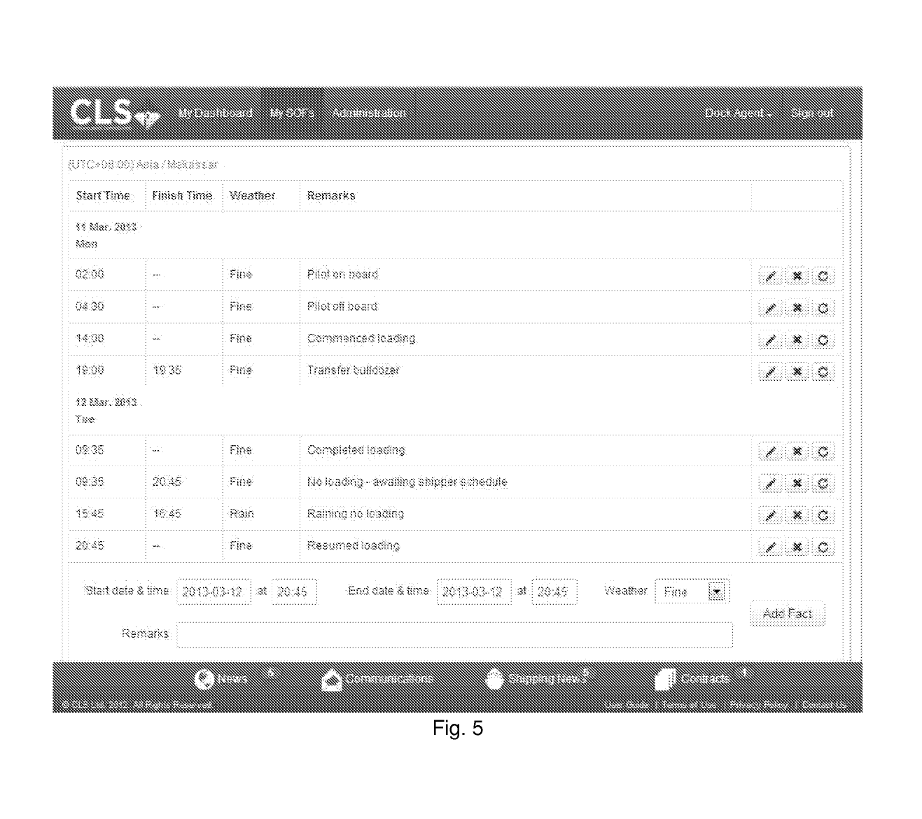

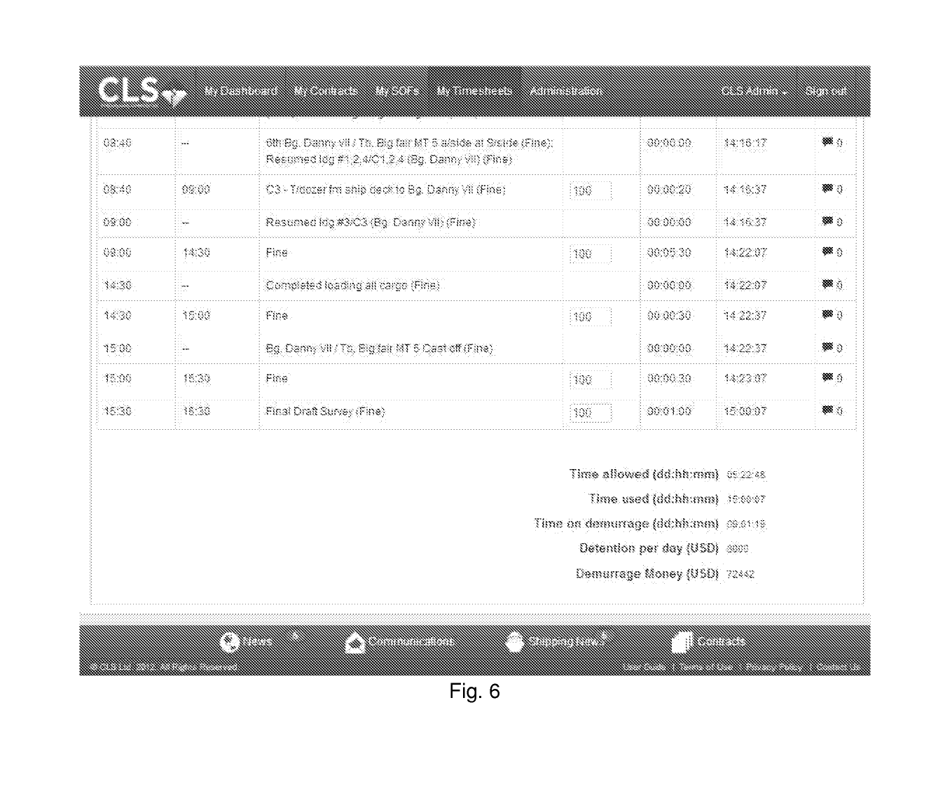

Referring now to FIG. 5, there is illustrated an example timesheet for a laytime and demurrage calculation using an electronic system in accordance with the disclosure. The timesheet may comprise: the SOF entries to be used in the laytime calculation; and the percentage time from the SOF entry to be used in the laytime calculation. Other documents may be uploaded to the server 60 for inclusion with the timesheet. The timesheet may be shared with other parties, by user selection. Once the timesheet is complete, the user may request an electronic signature using the server 60.

The server 60 may compute the time from each included SOF entry to be used in the laytime calculation and the total of the included time may also be computed and shown. A time allowed under the contract may also be shown. This may be retrieved from the contract information also stored at the server 60. If the subtraction of the total included time from the time allowed under the contract results in a negative value, demurrage is payable. This difference may be used to calculate the demurrage, using the other parameters as shown.

Although a specific embodiment of the disclosure has now been detailed, the skilled person will recognise various modifications may be possible. For instance, the disclosure is not limited to FOB and CNF contracts. Other types of commodity shipment contracts may be implemented, using similar processes. Importantly, such contracts include statements of fact and it is the electronic connection, storage and access to these statements of fact that allows automatic laytime calculation. Although the disclosure suggests use of a web application, other communication methods may be employed, such as client and server software.

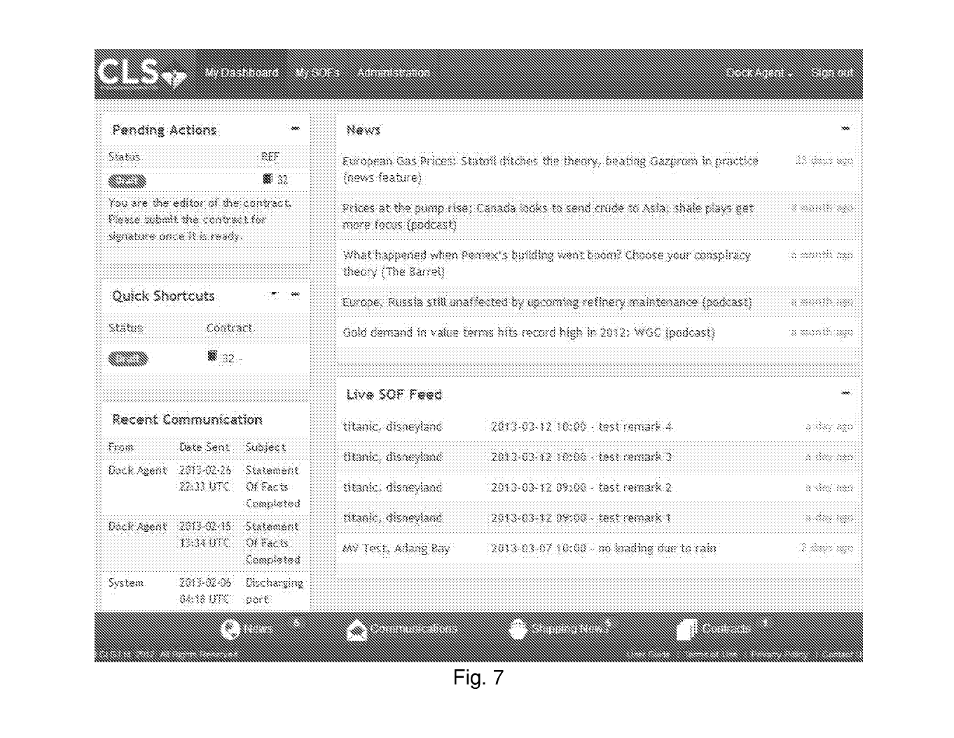

Referring next to FIG. 7, there is shown a sample user interface for the electronic system. It will be noted that the interface may be accessed via a web browser. The interface may provide a news feed, with relevant news information for the user. The user interface may further (or optionally alternatively) provide one or more of: a live SOF feed; pending actions; quick shortcuts; and recent communications. The user may access the system using an authentication procedure, which also identifies their status as a party within the shipping management. For example, in the sample user interface shown, the party is a shipping (or dock) agent.

Whilst the disclosure has been presented as a complete process operational on a single system, it will be recognised that alternatives are contemplated. For example, the electronic system or server 60 can be used to provide only part of the functionality described above. One such embodiment may only use the SOF creation and storage functionality. Additionally, the timesheet (laytime calculation) functionality may be used together with the SOF functionality to improve the laytime calculation in terms of efficiency, accuracy and in avoiding dispute. Additionally or alternatively, the contract formulation and/or storage functionality can be used alone. The skilled person may appreciate that additional benefits may be found when combinations of the functionalities are used, especially combinations involving the SOF functionality.

The foregoing description of the disclosure has been presented for the purposes of illustration and description. It is not intended to be exhaustive or to limit the invention to the precise form(s) disclosed. Persons skilled in the art will appreciate modifications, variations, substitutions, changes and equivalents are possible. The spirit and scope of the invention is to be understood on the basis of the appended claims.

1. A method of managing a commodity shipment comprising:
maintaining a Statement of Fact (SOF) on an electronic system; and
allowing electronic access to the SOF by one or more of a plurality of parties involved in the shipment using data communication.

2. The method of claim 1, wherein the parties involved in the shipment comprise one or more of: a shipment seller; a shipment buyer; a vessel owner; and a shipping agent.

3. The method of claim 1, wherein access involves one or more of: viewing; writing; and editing.

4. The method of claim 1, further comprising:
identifying that the SOF has been changed by one of the parties; and
communicating an indication that the SOF has been changed to at least one of the other parties.

5. The method of claim 1, further comprising:
receiving an assignment of a shipping agent or a command from a shipping agent; and
initialising the SOF upon receipt of the shipping agent assignment or command.

6. The method of claim 5, further comprising:
granting read permission for the SOF to one or more of: the shipment seller; shipment buyer; vessel owner; vessel charterer; and shipping agent.

7. The method of claim 6, further comprising:
granting write permission for the SOF to the shipping agent.

8. The method of claim 1, further comprising:
initialising a timesheet at the electronic system.

9. The method of claim 8, wherein one of the plurality of parties involved in the shipment is a charterer, the method further comprising:
granting read and edit permissions for the timesheet to the: charterer and vessel owner; or buyer and seller.

10. The method of claim 1, further comprising:
receiving a Notice of Readiness (NOR) at the electronic system from a shipping agent via data communication; and
requesting an electronic acceptance of the NOR from at least one of the parties.

11. The method of claim 1, further comprising:
calculating a laytime using the SOF.

12. The method of claim 11, further comprising:
initialising a timesheet at the electronic system; and
wherein the step of calculating the laytime uses the SOF and one or more variables stored in the timesheet.

13. The method of claim 11, further comprising:
receiving a plurality of facts at the electronic system from the shipping agent via data communication; and
storing the plurality of received facts as part of the SOF at the electronic system.

14. The method of claim 13, wherein the step of calculating a laytime using the SOF takes place in response to receiving a first fact from the plurality of facts at the electronic system.

15. The method of claim 13, further comprising:
receiving electronic indications from one or more of the parties regarding the facts; and
wherein the step of calculating the laytime uses the received electronic indications.

16. The method of claim 1, further comprising:
receiving information regarding a contract for the commodity shipment at the electronic system via data communication from one of the parties; and
formulating and electronically storing the contract based on the received information.

17. The method of claim 16, wherein the information comprises one or more of: the type of contract; information about at least some of the parties; an indication of a contract template; a cargo weight; a loading rate; a discharging rate; a laytime figure; a demurrage rate; and a despatch rate.

18. The method of claim 17, wherein the information about at least some of the parties comprises at least one of: name information; contact information; party status information; and electronic communication information.

19. The method of claim 16, further comprising:
allowing electronic access to the formulated contract to at least one of the other parties.

20. The method of claim 16, further comprising:
sending an electronic communication from the electronic system to at least some of the parties inviting the at least some of the parties to sign the contract; and
receiving an electronic signature from the invited parties.

21. The method of claim 16, further comprising:
calculating a laytime at the electronic system using the SOF and the contract.

22. The method of claim 21, further comprising:
initialising a timesheet at the electronic system; and
wherein the step of calculating the laytime uses the SOF and one or more variables stored in the contract, the timesheet or both.

23. A method of formulating a contract for a commodity shipment, the method comprising:
receiving information regarding the contract at an electronic system via data communication from one of a plurality of parties involved in the shipment; and
formulating and electronically storing the contract based on the received information.

24. The method of claim 23, wherein the information comprises one or more of: the type of contract; information about at least some of the parties; an indication of a contract template; a cargo weight; a loading rate; a discharging rate; a laytime figure; a demurrage rate; and a despatch rate.

25. The method of claim 24, wherein the information about at least some of the parties comprises at least one of: name information; contact information; party status information;
and electronic communication information.

26. The method of claim 23, further comprising:
allowing electronic access to the formulated contract to at least one of the other parties.

27. The method of claim 23, further comprising:
sending an electronic communication from the electronic system to at least some of the parties inviting the at least some of the parties to sign the contract; and
receiving an electronic signature from the invited parties.

28. A computer readable medium comprising a computer program configured to carry out the method of claim 1 when operated on a processor.

29. A computer readable medium comprising a computer program configured to carry out the method of claim 23 when operated on a processor.

30. An electronic system for managing a commodity shipment, comprising a processor configured to carry out the method according to claim 1.

31. An electronic system for managing a commodity shipment, comprising a processor configured to carry out the method according to claim 23.
